(19) United States
(12) Patent Application Publication
(10) Pub. No.: US 2026/0203975 A1
(43) Pub. Date: Jul. 16, 2026

(54) METHOD FOR GENERATING AN EFFECT, METHOD FOR GENERATING AN EFFECT IMAGE, ELECTRONIC DEVICE AND STORAGE MEDIUM

(71) Applicant: Beijing Zitiao Network Technology Co., Ltd., Haidian District, Beijing (CN)

(72) Inventors: Shizeng YAN, Beijing (CN); Kewei CHEN, Beijing (CN)

(21) Appl. No.: 19/136,672

(22) PCT Filed: Dec. 6, 2023
(86) PCT No.: PCT/CN2023/136811

§ 371 Date: Jun. 6, 2025

(30) Foreign Application Priority Data
Dec. 7, 2022 (CN) 202211566973.2

(51) Int. Cl. G06T 11/60; G06T 15/04; G06V 40/16

(52) U.S. Cl. CPC G06T 11/60; G06T 15/04; G06V 40/171

(57) ABSTRACT

Embodiments of the present disclosure provide methods and apparatus for generating a special effect item and a special effect image, a device, and a storage medium. The method for generating a special effect image comprises: creating a special effect component on the basis of a first action triggered by a user, wherein the special effect component may comprise a deformable reference object facial image, and a reference facial keypoint is provided on a reference object face; detecting a moving operation by the user on the reference facial keypoint, and obtaining target position information after the facial keypoint has moved; detecting special effect parameters set by the user; and generating a deformation special effect item according to the target position information and the special effect parameters. According to the embodiments of the present disclosure, the user generates a special effect item by moving a reference facial keypoint on the special effect component according to actual needs, and performs special effect processing on a target image on the basis of the generated special effect item. Thus, the efficiency and flexibility of generating special effect items can be improved, and the display content of images can also be enriched, thereby improving the diversity of images.

The present application claims the priority and benefits of Chinese Patent Application No. 202211566973.2, filed on Dec. 7, 2022, which is incorporated herein by reference in its entirety as part of the present application.

### TECHNICAL FIELD

Embodiments of the present disclosure relate to a method for generating an effect, a method for generating an effect image, an apparatus, a device and a storage medium.

### BACKGROUND

In recent years, image processing applications (App) have developed rapidly, come into the lives of users, and gradually enriched their spare time. The users can record their lives in the form of videos, photos, etc., and can reprocess images through effect technologies provided on the image processing APP, for example: effect processing on animals or people in the images, so that the images can be expressed in a richer form.

### SUMMARY

The embodiment of the disclosure provides a method, an apparatus, a device and a storage medium for generating an effect and an effect image. The present disclosure can perform effect processing on animals in images, thus enriching the display content of the images, and improving the diversity of the images.

In a first aspect, an embodiment of the present disclosure provides a method for generating an effect, including:
creating an effect component based on a first operation triggered by a user, in which the effect component includes a deformable face image of a reference object, and reference face key points are set on a face of the reference object;
detecting a moving operation of the user on the reference face key points and obtaining target position information of the reference face key points after being moved;
detecting an effect parameter set by the user; and
generating a deformation effect according to the target position information and the effect parameter, in which the deformation effect is used for performing deformation effect processing on a face of an object in a target image, and a category of the object in the target image is identical to a category of the reference object.

In a second aspect, the embodiment of the present disclosure also provides a method for generating an effect image, including:
obtaining a target image and a deformation effect;
determining initial face key point information of an object in the target image;
transforming the initial face key point information based on the deformation effect to obtain transformed face key point information;
determining target deformation information according to the transformed face key point information and the initial face key point information; and
performing deformation effect processing on the target image based on the target deformation information to obtain a target effect image.

In a third aspect, an embodiment of the present disclosure also provides an apparatus for generating an effect, including:
an effect component creating module, configured to create an effect component based on a first operation triggered by a user, in which the effect component includes a deformable face image of a reference object, and reference face key points are set on a face of the reference object;
a face key point movement module, configured to detect a moving operation of the user on the reference face key points and obtain target position information of the reference face key points after being moved;
an effect parameter detection module, configured to detect an effect parameter set by the user; and
an effect generation module, configured to generate a deformation effect according to the target position information and the effect parameter, in which the deformation effect is used for performing deformation effect processing on a face of an object in a target image, and a category of the object in the target image is identical to a category of the reference object.

In a fourth aspect, an embodiment of the present disclosure also provides an apparatus for generating an effect image, including:
a deformation effect acquisition module, configured to obtain a target image and a deformation effect;
an initial face key point information determination module, configured to determine initial face key point information of an object in the target image;
a transformed face key point information acquisition module, configured to transform the initial face key point information based on the deformation effect to obtain transformed face key point information;
a target deformation information determination module, configured to determine target deformation information according to the transformed face key point information and the initial face key point information; and
a target effect image acquisition module, configured to perform deformation effect processing on the target image based on the target deformation information to obtain a target effect image.

In a fifth aspect, an embodiment of the present disclosure also provides an electronic device, which includes:
one or more processors;
a storage apparatus is configured to store one or more programs, in which the one or more programs, when executed by the one or more processors, cause the one or more processors to implement the method for generating the effect or the method for generating the effect image according to the embodiment of the present disclosure.

In a fourth aspect, the embodiment of the present disclosure also provides a storage medium including computer-executable instructions, in which the computer-executable instructions, when executed by a computer processor, are used for executing the method for generating the effect or the method for generating the effect image according to the embodiment of the present disclosure.

### BRIEF DESCRIPTION OF DRAWINGS

The above and other features, advantages and aspects of the embodiments of the present disclosure will become more apparent with reference to the following detailed description taken in conjunction with the accompanying drawings. Throughout the drawings, the same or similar reference numerals indicate the same or similar elements. It should be understood that the drawings are schematic, and the original and elements are not necessarily drawn to scale.

FIG. 1 is a schematic diagram of a flow of a method for generating an effect provided by an embodiment of the present disclosure;

FIG. 2a is an example diagram of a face image of a reference object provided by an embodiment of the present disclosure;

FIG. 2b is an example diagram of a face image of a reference object provided by an embodiment of the present disclosure;

FIG. 3a is a schematic diagram of an effect component provided by an embodiment of the present disclosure;

FIG. 3b is a schematic diagram of an effect component provided by an embodiment of the present disclosure;

FIG. 4a is an example diagram of deformation on a face image of a reference object provided by an embodiment of the present disclosure;

FIG. 4b is an example diagram of deformation on a face image of a reference object provided by an embodiment of the present disclosure;

FIG. 5 is an example diagram of an effect editing interface provided by an embodiment of the present disclosure;

FIG. 6a is a schematic diagram of a flow of a method for generating an effect image provided by an embodiment of the present disclosure;

FIG. 6b is an example of a target effect diagram provided by an embodiment of the present disclosure;

FIG. 6c is an example diagram of a target effect diagram provided by an embodiment of the present disclosure;

FIG. 7 is a structural schematic diagram of an apparatus for generating an effect provided by an embodiment of the present disclosure;

FIG. 8 is a structural schematic diagram of an apparatus for generating an effect image provided by an embodiment of the present disclosure; and

FIG. 9 is a structural schematic diagram of an electronic device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps recited in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; The term “another embodiment” means “at least one other embodiment”; The term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “a” and “a plurality” mentioned in this disclosure are schematic rather than limiting, and those skilled in the art should understand that unless the context clearly indicates otherwise, they should be understood as “one or more”.

The names of messages or information exchanged between a plurality of apparatuses in the embodiment of the present disclosure are only used for illustrative purposes, and are not used to limit the scope of these messages or information.

It is to be understood that before using the technical solutions disclosed in each embodiment of the present disclosure, it is needed to inform the type, scope of use, and use scenarios of the personal information involved in the present disclosure to a user and gain the authorization of the user through appropriate methods in accordance with relevant laws and regulations.

For example, prompt information is transmitted to the user in response to an active request of the user so as to clearly prompt the user, the operation requested to be executed needs to gain and use the personal information of the user. Therefore, the user can autonomously select whether to provide personal information for software or hardware such as an electronic device, an application, a server or a storage medium executing the operation of the technical solution of the present disclosure according to the prompt information.

As an optional but non-limited implementation mode, the mode of transmitting the prompt information to the user in response to receiving the active request of the user can be a popup window mode, and the prompt information can be presented in a character mode in the popup window. In addition, the popup window can also carry a selection control for the user to select “Agree” or “Disagree” to provide personal information for the electronic device.

It is to be understood that the above-mentioned processing of informing and gaining the authorization of the user is only indicative and do not limit the implementation mode of the present disclosure, and other modes that meet the relevant laws and regulations can also be applied to the implementation mode of the present disclosure.

It is to be understood that data involved in this technical solution (including but not limited to the data itself, acquisition or use of data) shall comply with the requirements of relevant laws and regulations and relevant provisions.

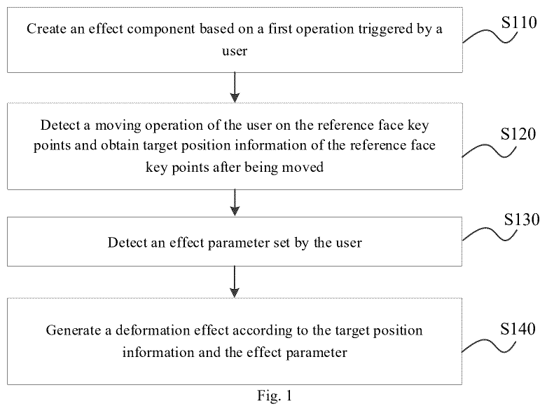

FIG. 1 is a schematic diagram of a flow of a method for generating an effect image provided by an embodiment of the present disclosure. The embodiment of the present disclosure is suitable for a situation of performing effect processing on an image; the method may be executed by a generation apparatus, and the apparatus may be realized in a form of software and/or hardware, optionally, realized through an electronic device which may be a mobile terminal, a PC terminal or a server and the like.

As shown in FIG. 1, the method for generating an effect image includes:

S110, create an effect component based on a first operation triggered by a user.

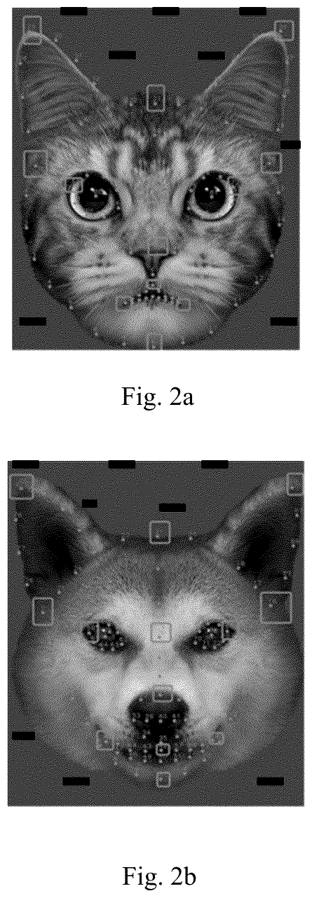

The effect component is a deformable face image of a reference object, and reference face key points are set on a face of the reference object. In the embodiment, a reference object may be a standard virtual object constructed by a technician. The object may be any object with a face, for example, person or an animal etc., and the animal may be: a cat, a dog, a sheep and the like. In the embodiment, the object is the animal, and the face image of the reference object may be a reference animal face image, for example: a reference cat face image or a reference dog face image. Exemplarily, FIG. 2a-FIG. 2b are example diagrams of the face image of the reference object in the embodiment. FIG. 2a is the reference cat face image, and the reference face key points are set on the cat face; and FIG. 2b is the reference dog face image, and the reference face key points are set on the dog face.

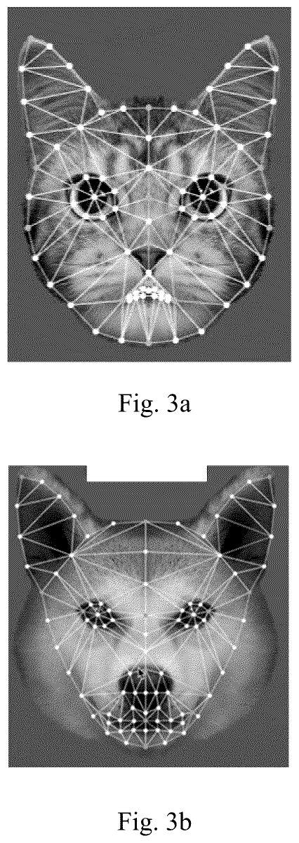

The effect component may be created in advance and integrated in an effect tool. In the embodiment, the reference face key points on the effect component are connected through lines so as to form a triangular grid, and the user may move the reference face key points to deform the face of the reference object. Exemplarily, FIG. 3a-FIG. 3b are schematic diagrams of the effect component in the embodiment. As shown in FIG. 3a, the effect component includes the cat face with a reference face key, the cat face is provided with the reference face key points which are connected with one another; and as shown in FIG. 3b, the effect component is the dog face with the reference face key, and the dog face is provided with the reference face key points which are connected with one another. In the embodiment, in response to that the user opens the effect tool, the user may click a creation button to create the effect component in an editing interface, which facilitates later editing on the effect component.

S120, detect a moving operation of the user on the reference face key points and obtain target position information of the reference face key points after being moved.

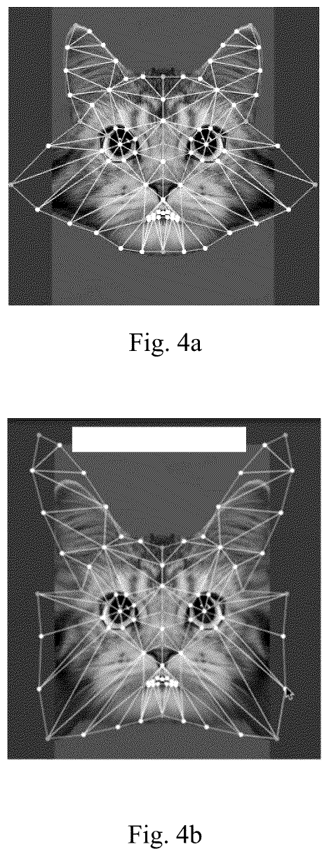

In the embodiment, the user may perform the moving operation on the reference face key points, and in response to that the user moves a certain face key point, other face key points may be driven to move, thus causing the face of the reference object to be deformed. Exemplarily, FIG. 4a-FIG. 4b are example diagrams of deformation of the face image of the reference object; as shown in FIG. 4a, the user may move the key points on the faces of both sides of the cat in the image in FIG. 3a to stretch the cat face; and as shown in FIG. 4b, the user may move the key points on the faces of the both sides of the cat and the key points on two ears in the image in FIG. 3a to stretch the face and ears of the cat.

Optionally, the process of detecting the moving operation of the user on the reference face key points and obtain the target position information of the reference face key points after being moved may be: extracting at least one editable key point from the reference face key points based on a selection operation triggered by the user; marking the at least one editable key point; and detecting the moving operation of the user on the at least one editable key point being marked and obtaining target position information of the at least one editable key point after movement of the at least one editable key point.

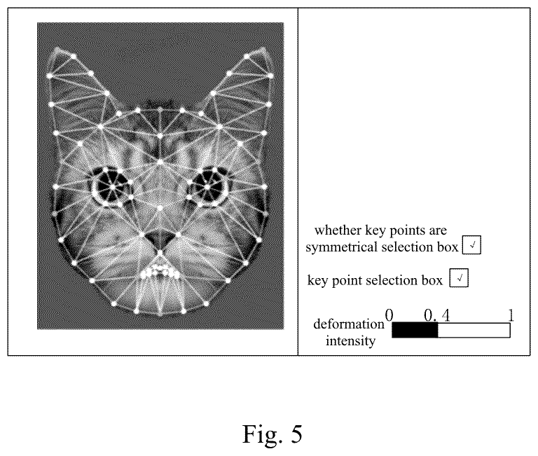

The at least one editable key point are all or part of the reference face key points. FIG. 5 is an example diagram of an effect editing interface in an embodiment of the present disclosure. As shown in FIG. 5, the effect component is displayed on the left of an effect tool editing interface, and a plurality of attribute selection boxes are displayed on the right of the effect tool editing interface, which may include: a whether key points are symmetrical selection box, a key point selection box and an effect parameter setting box. In the embodiment, in response to that the user does not check in the key point selection box, the effect tool determines the set face key points in the reference face key points as the at least one editable key point, and determines the rest as at least one non-editable key point. As shown in FIG. 2a-FIG. 2b, serial numbers are set for the reference face key points, in which, the framed reference face key points are the set face key points, namely the key points with the serial numbers of (0, 8, 16, 21, 28, 31, 42, 46, 54, 58, 65, 79, 86). In response to that the user checks in the key point selection box, all the reference face key points will be determined as the at least one editable key point.

The mode of marking the at least one editable key point may be: framing the editable points with a rectangular frame, or changing the colors of the at least one editable key point. For example, the color of the at least one editable key point is blue, and the color of the at least one non-editable key point is white.

In the embodiment, after the at least one editable key point is marked, the moving operation of the user on the at least one editable key point being marked is detected and obtain the target position information of the at least one editable key point after movement of the at least one editable key point. In the embodiment, only the target position information of the at least one editable key point after movement is obtained, the target position information of all reference face key points after movement does not need to be obtained, and thus computing resources can be saved.

S130, detect an effect parameter set by the user.

The effect parameter may include a parameter representing deformation intensity, and the effect parameter may be any value between 0 and 1, that is, the effect parameter may be understood as a deformation intensity coefficient. As shown in FIG. 5, the user may set any effect parameter in the deformation intensity setting box. In the embodiment, the user can set the effect parameter, thus improving the flexibility and diversity of effects in editing.

Optionally, as shown in FIG. 5, in response to that the user checks in the whether key points are symmetrical selection box, and the user moves one reference face key point, the effect tool will automatically move the reference face key point symmetrical to this reference face key point by the same amplitude in a mirroring mode, in this way, symmetrical deformation can be conducted on the object face, and thus the convenience of editing of the effect is improved.

S140, generate a deformation effect according to the target position information and the effect parameter.

The deformation effect is used for performing deformation effect processing on a face of an object in a target image, and a category of the object in the target image is identical to a category of the reference object.

The deformation effect records the deformation information that is determined based on the initial position information of the face key points, the target position information of the at least one editable key point after movement, and the effect parameters, and the deformation information may be represented by a matrix. In the embodiment, after the user edits the effect component, the user may click “Export” option in the effect tool, or select “Generate Effect” to generate the deformation effect.

Specifically, the process of generating the deformation effect according to the target position information and the effect parameters may be: determine an effect transformation matrix according to the target position information and the effect parameter; and encapsulate an effect transformation matrix pair and obtain the deformation effect.

The effect transformation matrix may be an affine transformation matrix. Specifically, the process of encapsulating an effect transformation matrix pair and obtaining the deformation effect may be: firstly, encapsulate the effect transformation matrix pair, and obtain an effect package, and then integrate the effect package on a terminal device, and obtain the effect. In the embodiment, the mode of determining the effect transformation matrix according to the target position information and the effect parameters may be: perform a series of computation on the initial position information of the reference face key points, the target position information of the at least one editable key point after the movement, the effect parameters and other information recorded in the effect to obtain the effect transformation matrix. In the embodiment, the effect transformation matrix pair is encapsulated to obtain the deformation effect, and thus the precision of the effect can be improved.

Optionally, the mode of determining the effect transformation matrix according to the target position information and the effect parameters may be: in response to the at least one editable key point being all the reference face key points, obtain initial position information of the reference face key points before movement of the reference face key points; and determine an initial effect transformation matrix according to initial position information and the target position information of the reference face key points, and determine a final effect transformation matrix according to the initial effect transformation matrix and the effect parameter.

The initial position information of the reference face key points before movement of the reference face key points is stored in the effect tool and may be directly obtained. The initial position information of the reference face key points before movement of the reference face key points may form an initial position information sequence, and the target position information of the reference face key points after movement may form a target position information sequence. The mode of determining the initial effect transformation matrix according to the initial position information and the target position information of the reference face key points may be: perform least square method estimation and/or maximum likelihood estimation on the initial position information sequence and the target position information sequence to obtain the initial effect transformation matrix. Specifically, the mode of determine the final effect transformation matrix according to the initial effect transformation matrix and the effect parameters may be: take the effect parameters as coefficients to be multiplied by the initial effect transformation matrix to obtain the final effect transformation matrix. In the embodiment, the effect transformation matrix is determined based on all the reference face key points, so that the precision of the effect transformation matrix can be improved.

Optionally, the mode of determining the effect transformation matrix according to the target position information and the effect parameters may be: in response to the at least one editable key point being part of the reference face key points, obtain initial position information of the reference face key points before movement of the reference face key points; determine an intermediate transformation matrix according to initial position information and target position information of the at least one editable key point; transform the at least one non-editable key point based on the intermediate transformation matrix to obtain target position information of the at least one non-editable key point; determine initial effect transformation matrix according to initial position information and target position information of the reference face key points; and determine a final effect transformation matrix according to the initial effect transformation matrix and the effect parameters.

The reference face key points include the at least one editable key point and the at least one non-editable key point. The initial position information of the reference face key points before movement of the reference face key points and the target position information of the at least one editable key point after movement are stored in the effect tool, and may be directly obtained. In the embodiment, the process of determining the intermediate transformation matrix according to the initial position information and the target position information of the at least one editable key point may be: perform least square estimation and/or maximum likelihood estimation on the initial position information sequence and the target position information sequence of the at least one editable key point to obtain the intermediate transformation matrix. The process of transforming the at least one non-editable key point based on the intermediate transformation matrix may be: perform point multiplication operation on the intermediate transformation matrix and the initial position information of the at least one non-editable key point to obtain the target position information of the at least one non-editable key point. After the target position information of the at least one non-editable key point is obtained, all the target position information representing the face key points may be obtained because the target position information of the at least one editable key point is known. Specifically, the process of determining the initial effect transformation matrix according to the initial position information and the target position information of the reference face key points may be: perform least square estimation and/or maximum likelihood estimation on the corresponding initial position information sequences and target position information sequences of all the reference face key points to obtain the initial effect transformation matrix. Specifically, the mode of determining the final effect transformation matrix according to the initial effect transformation matrix and the effect parameters may be: multiply the effect parameters as the coefficients with the initial effect transformation matrix to obtain the final effect transformation matrix. In the embodiment, the effect transformation matrix is determined based on part of the reference face key points, so that the computation amount can be reduced, the computation resources can be saved, and the processing efficiency can be improved.

Optionally, the mode of determining the initial effect transformation matrix according to the initial position information and the target position information of the reference face key points may be: obtain a fixed key point in the reference face key points; update target position information of the fixed key point to initial position information of the fixed key point; and determine the effect transformation matrix according to the initial position information of the reference face key points and updated target position information.

The reference face key points in which the position information of the fixed key points may not be changed are the at least one editable key point and/or at least one non-editable key point. For example, the fixed key points may be several key points located on the central axis of the face. The fixed key points may be recorded in the effect tool, and may be directly obtained from the effect tool. Specifically, after the target position information of the reference face key points is obtained, the position information of the fixed key points is called back to the initial position information to ensure that the positions of the fixed key points do not move. The mode of determining the initial effect transformation matrix according to the initial position information of the reference face key points and the updated target position information may be: perform least square method estimation and/or maximum likelihood estimation on the corresponding initial position information sequences and updated target position information sequences of the reference face key points to obtain the effect transformation matrix. In the embodiment, the target position information of the fixed key points is updated into the initial position information of the fixed key points, so that the form of the object face can be prevented from being changed sharply, and the object face in the target image is prevented from being distorted seriously.

According to the technical solution of the embodiment, the method includes: creating the effect component based on the first operation triggered by the user, in which, the effect component is the deformable face image of the reference object, and the reference face key points are set on the face of the reference object; detecting the moving operation of the user on the reference face key point to obtain the target position information of the reference face key points after being moved; and detecting the effect parameters set by the user; generating the deformation effect according to the target position information and the effect parameters, in which, the deformation effect is used for performing deformation effect processing on the face of the object in the target image, and the object in the target image is the same as the reference object in category. In the embodiment of the present disclosure, the user can move the reference face key points on the effect component and set the effect parameters to generate the effect according to actual requirements, thus the generation efficiency and flexibility of the effect can be improved, the display content of the image can be enriched, and the diversity of the image is improved.

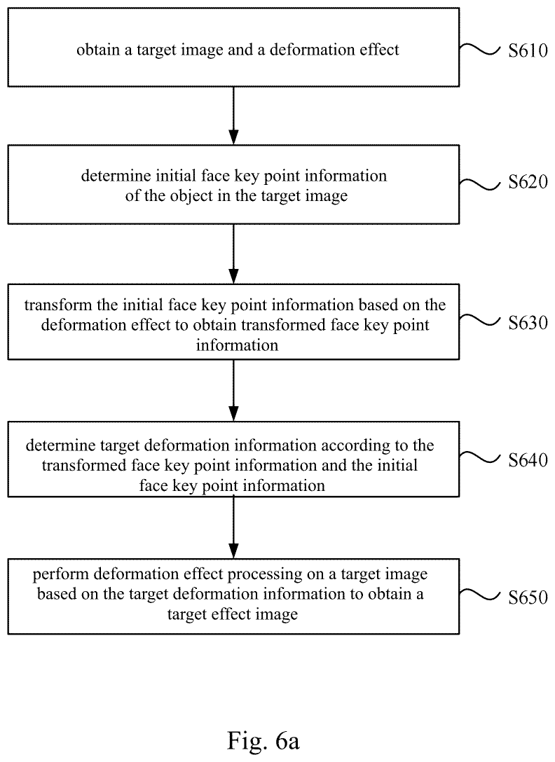

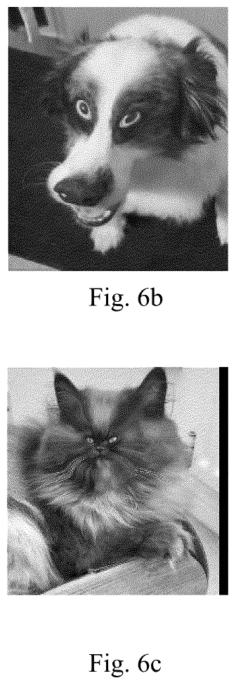

FIG. 6a is a flowchart of a method for generating an effect image provided by an embodiment of the present disclosure. The embodiment of the present disclosure is suitable for a situation of performing effect processing on an image; the method may be executed by a apparatus for generating the effect image, and the apparatus may be realized in a form of software and/or hardware, optionally, realized through an electronic device which may be a mobile terminal, a PC terminal or a server and the like.

As shown in FIG. 6a, the method for generating an effect image includes:

S610, obtain a target image and a deformation effect.

The target image includes a category of an object is identical to a category of a reference object in the deformation effect. It is assumed that the reference object in the deformation effect is a cat, the target object will include the cat. The target image may be an image collected by the terminal device in real time, or an image obtained from a local memory or a server database. The deformation effect may be generated in the mode of the above embodiment, and is integrated in an image application; and the effect may be obtained through a calling interface in the image application. In the embodiment, the terminal device can call the preset deformation effect to perform effect processing on the target image so as to obtain the target effect graph.

S620, determine initial face key point information of the object in the target image.

The initial face key points may be understood as the face key points of the object in the target image, and the initial face key point information may be the initial position information of the face key points and represented by coordinates. In the embodiment, any object face recognition algorithm may be adopted to obtain the initial face key point information in the target image, which is not limited here.

S630, transform the initial face key point information based on the deformation effect to obtain transformed face key point information.

In the embodiment, the initial face key point information is transformed based on the deformation effect, and the mode for obtaining the transformed face key point information may be: extracting effect transformation information corresponding to the deformation effect; and transforming the initial face key point information based on the effect transformation information to obtain the transformed face key point information.

The effect transformation information may be represented by the effect transformation matrix. Specifically, the process of transforming the initial face key point information based on the effect transformation information may be understood as follows: performing point multiplication operation on the effect transformation matrix corresponding to the effect transformation information and position information of the initial face key points to obtain position information of the face key points after transformation, namely the transformed face key point information.

S640, determine target deformation information according to the transformed face key point information and the initial face key point information.

The target deformation information may be represented by a matrix. The initial face key point information may form an initial face key point position information sequence; the transformed face key point information may form a transformed face key point position information sequence; and the process of determining the target deformation information according to the transformed face key point information and the initial face key point information may be: performing least square method estimation and/or maximum likelihood estimation on the initial face key point position information sequence and the transformed face key point position information sequence to obtain a target transformation matrix.

S650, perform deformation effect processing on a target image based on the target deformation information to obtain a target effect image.

Optionally, the mode of performing deformation effect processing on the target image based on target deformation information to obtain the target effect image may be: transforming texture mapping coordinates according to the target deformation information; sampling a pixel value from the target image based on the transformed texture mapping coordinate; and rendering the pixel value being sampled to obtain the target effect image.

The texture mapping may be understood as a UV map, and the texture mapping coordinates may be understood as UV coordinates. The process of transforming the texture mapping coordinates according to the target deformation information may be: performing point multiplication operation on the matrix corresponding to the target deformation information and the texture mapping coordinates to obtain transformed texture mapping coordinates; then sampling pixel values from the target image based on the transformed texture mapping coordinates; and finally, rendering the pixel value being sampled to obtain the target effect image. In the embodiment, the texture mapping coordinates are transformed according to the target deformation information, so that the accuracy of effect processing can be improved.

Exemplarily, FIG. 6b-FIG. 6c are example diagrams of the target effect image; FIG. 6b is an effect image generated by deforming the face of the dog; and FIG. 6c is an effect image generated by deforming the face of the cat.

According to the technical scheme of the embodiment of the disclosure, obtaining a target image and a deformation effect; determining initial face key point information of an object in the target image; transforming the initial face key point information based on the deformation effect to obtain transformed face key point information; determining target deformation information according to the transformed face key point information and the initial face key point information; and performing deformation effect processing on the target image based on the target deformation information to obtain a target effect image. In the embodiment of the present disclosure, the target image is specially processed based on the deformation effect, thus the generation efficiency and flexibility of the effect can be improved, the display content of the image can be enriched, and the diversity of the image is improved.

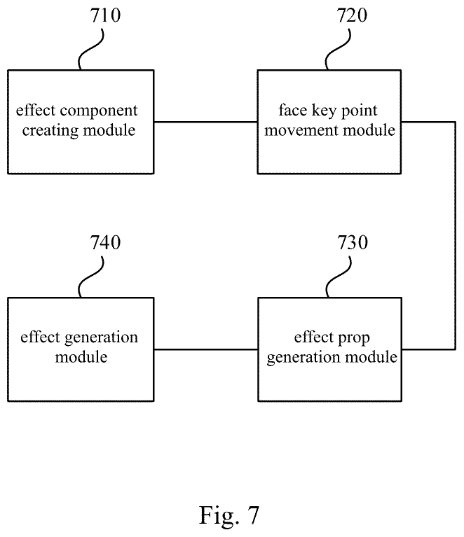

FIG. 7 is a structural schematic diagram of an apparatus for generating an effect provided by an embodiment of the present disclosure. As shown in FIG. 7, the apparatus for generating the effect includes: an effect component creating module 710, a face key point movement module 720, an effect parameter detection module 730, and an effect generation module 740.

The effect component creating module 710 is configured to create an effect component based on a first operation triggered by a user, in which the effect component includes a deformable face image of a reference object, and reference face key points are set on a face of the reference object;

The face key point movement module 720 is configured to detect a moving operation of the user on the reference face key points and obtain target position information of the reference face key points after being moved.

The effect parameter detection module 730 is configured to detect an effect parameter set by the user; and

The effect generation module 740 is configured to generate a deformation effect according to the target position information and the effect parameter, in which the deformation effect is used for performing deformation effect processing on a face of an object in a target image, and a category of the object in the target image is identical to a category of the reference object.

Optionally, the face key point movement module 720 is further configured to:
extract at least one editable key point from the reference face key points based on a selection operation triggered by the user, in which the at least one editable key point is all or part of the reference face key points;
mark the at least one editable key point; and
detect a moving operation of the user on the at least one editable key point being marked and obtain target position information of the at least one editable key point after movement of the at least one editable key point.

Optionally, the effect generation module 740 is further configured to:
determine an effect transformation matrix according to the target position information and the effect parameter; and
encapsulate an effect transformation matrix pair and obtain the deformation effect.

Optionally, the effect generation module 740 is further configured to:
in response to the at least one editable key point being all the reference face key points, obtain initial position information of the reference face key points before movement of the reference face key points;
determine an initial effect transformation matrix according to the initial position information and the target position information of the reference face key points; and
determine a final effect transformation matrix according to the initial effect transformation matrix and the effect parameter.

Optionally, the effect generation module 740 is further configured to:
in response to the at least one editable key point being part of the reference face key points, obtain initial position information of the reference face key points before movement of the reference face key points, in which the reference face key points include the at least one edible key point and at least one non-edible key point;
determine an intermediate transformation matrix according to initial position information and target position information of the at least one editable key point;
transform the at least one non-editable key point based on the intermediate transformation matrix to obtain target position information of the at least one non-editable key point;
determine an initial effect transformation matrix according to the initial position information and the target position information of the reference face key points; and
determine a final effect transformation matrix according to the initial effect transformation matrix and the effect parameter.

Optionally, the effect generation module 740 is further configured to:
obtain a fixed key point in the reference face key points, in which the fixed key point is a part of the at least one editable key point and/or a part of the at least one non-editable key point;
update target position information of the fixed key point to initial position information of the fixed key point; and
determine the initial effect transformation matrix according to the initial position information and updated target position information of the reference face key points.

Optionally, the effect parameter includes a parameter representing deformation intensity.

The apparatus for generating the effect provided by the embodiment of the present disclosure can execute the method for generating the effect provided by any embodiment of the present disclosure, and has corresponding functional modules and beneficial effects.

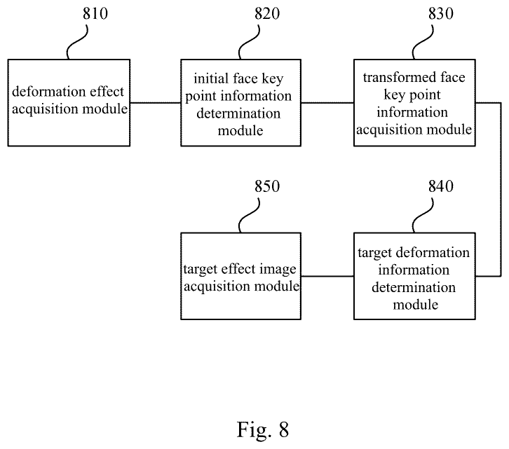

FIG. 8 is a structural schematic diagram of an apparatus for generating an effect image provided by an embodiment of the present disclosure. As shown in FIG. 8, the apparatus for generating the effect image includes: a deformation effect acquisition module 810, an initial face key point information determination module 820, a transformed face key point information acquisition module 830, a target deformation information determination module 840 and a target effect image acquisition module 850.

The deformation effect acquisition module 810 is configured to obtain a target image and a deformation effect.

The initial face key point information determination module 820 is configured to determine initial face key point information of an object in the target image.

The transformed face key point information acquisition module 830 is configured to transform the initial face key point information based on the deformation effect to obtain transformed face key point information.

The target deformation information determination module 840 is configured to determine target deformation information according to the transformed face key point information and the initial face key point information.

The target effect image acquisition module 850 is configured to perform deformation effect processing on the target image based on the target deformation information to obtain a target effect image.

Optionally, the transformed face key point information acquisition module 830 is further configured to:
extract effect transformation information corresponding to the deformation effect; and
transform the initial face key point information based on the effect transformation information to obtain the transformed face key point information.

Optionally, the target effect image acquisition module 850 is further configured to:
transform a texture mapping coordinate according to the target deformation information;
sample a pixel value from the target image based on a transformed texture mapping coordinate; and
render the pixel value being sampled to obtain the target effect image.

It is worth noting that each unit and module included in the above apparatus is only divided according to functional logic, but it is not limited to the above division, as long as corresponding functions can be realized; In addition, the specific names of each functional unit are only for the convenience of distinguishing each other, and are not used to limit the protection scope of the disclosed embodiment.

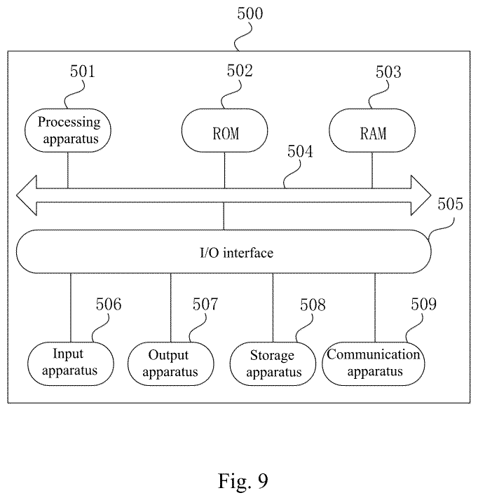

FIG. 9 is a structural schematic diagram of an electronic device provided by an embodiment of the present disclosure. Referring to FIG. 9, FIG. 9 illustrates a schematic structural diagram of an electronic device 500 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 9 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of messages or information exchanged between a plurality of apparatuses in the embodiment of the present disclosure are only used for illustrative purposes, and are not used to limit the scope of these messages or information.

The electronic device provided by the embodiment of the present disclosure belongs to the same inventive concept as the generation method of the special effect diagram provided by the above embodiment, and the technical details not described in detail in this embodiment can be found in the above embodiment, and this embodiment has the same beneficial effects as the above embodiment.

Embodiments of the present disclosure provide a computer storage medium having stored thereon a computer program which, when executed by a processor, implements the method for generating the effect image provided by the above embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:

The above-mentioned computer-readable medium carries one or more programs, and when the one or more programs are executed by the electronic device, the electronic device is caused to: create an effect component based on a first operation triggered by a user, in which the effect component includes a deformable face image of a reference object, and reference face key points are set on a face of the reference object; detect a moving operation of the user on the reference face key points and obtain target position information of the reference face key points after being moved; detect an effect parameter set by the user; and generate a deformation effect according to the target position information and the effect parameter, in which the deformation effect is used for performing deformation effect processing on a face of an object in a target image, and a category of the object in the target image is identical to a category of the reference object. Or obtain a target image and a deformation effect; determine initial face key point information of an object in the target image; transform the initial face key point information based on the deformation effect to obtain transformed face key point information; determine target deformation information according to the transformed face key point information and the initial face key point information; and perform deformation effect processing on the target image based on the target deformation information to obtain a target effect image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the subject matter has been described in language specific to structural features and/or method logic actions, it is to be understood that the subject matter defined in the appended claims is not necessarily limited to the specific features or actions described above. On the contrary, the specific features and actions described above are merely example forms of implementing the claims.

1. A method for generating an effect, comprising:
creating an effect component based on a first operation triggered by a user, wherein the effect component comprises a deformable face image of a reference object, and reference face key points are set on a face of the reference object;
detecting a moving operation of the user on the reference face key points and obtaining target position information of the reference face key points after being moved;
detecting an effect parameter set by the user; and
generating a deformation effect according to the target position information and the effect parameter, wherein the deformation effect is used for performing deformation effect processing on a face of an object in a target image, and a category of the object in the target image is identical to a category of the reference object.

2. The method according to claim 1, wherein the detecting a moving operation of the user on the reference face key points and obtaining target position information of the reference face key points after being moved, comprises:
extracting at least one editable key point from the reference face key points based on a selection operation triggered by the user, wherein the at least one editable key point is all or part of the reference face key points;
marking the at least one editable key point; and
detecting a moving operation of the user on the at least one editable key point being marked and obtaining target position information of the at least one editable key point after movement of the at least one editable key point.

3. The method according to claim 2, wherein the generating a deformation effect according to the target position information and the effect parameter, comprises:
determining an effect transformation matrix according to the target position information and the effect parameter; and
encapsulating an effect transformation matrix pair and obtaining the deformation effect.

4. The method according to claim 3, wherein the determining an effect transformation matrix according to the target position information and the effect parameter, comprises:
in response to the at least one editable key point being all the reference face key points, obtaining initial position information of the reference face key points before movement of the reference face key points;
determining an initial effect transformation matrix according to the initial position information and the target position information of the reference face key points; and
determining a final effect transformation matrix according to the initial effect transformation matrix and the effect parameter.

5. The method according to claim 3, wherein the determining an effect transformation matrix according to the target position information and the effect parameter, comprises:
in response to the at least one editable key point being part of the reference face key points, obtaining initial position information of the reference face key points before movement of the reference face key points, wherein the reference face key points comprise the at least one edible key point and at least one non-edible key point;
determining an intermediate transformation matrix according to initial position information and target position information of the at least one editable key point;
transforming the at least one non-editable key point based on the intermediate transformation matrix to obtain target position information of the at least one non-editable key point;
determining an initial effect transformation matrix according to the initial position information and the target position information of the reference face key points; and
determining a final effect transformation matrix according to the initial effect transformation matrix and the effect parameter.

6. The method according to claim 5, wherein the determining an initial effect transformation matrix according to the initial position information and the target position information of the reference face key points, comprises:
obtaining a fixed key point in the reference face key points, wherein the fixed key point is a part of the at least one editable key point and/or a part of the at least one non-editable key point;
updating target position information of the fixed key point to initial position information of the fixed key point; and
determining the initial effect transformation matrix according to the initial position information and updated target position information of the reference face key points.

7. The method according to any one of claims 1 to 6, wherein the effect parameter comprises a parameter representing deformation intensity.

8. A method for generating an effect image, comprising:
obtaining a target image and a deformation effect;
determining initial face key point information of an object in the target image;
transforming the initial face key point information based on the deformation effect to obtain transformed face key point information;
determining target deformation information according to the transformed face key point information and the initial face key point information; and
performing deformation effect processing on the target image based on the target deformation information to obtain a target effect image.

9. The method according to claim 8, wherein the transforming the initial face key point information based on the deformation effect to obtain transformed face key point information, comprises:
extracting effect transformation information corresponding to the deformation effect; and
transforming the initial face key point information based on the effect transformation information to obtain the transformed face key point information.

10. The method according to claim 8 or 9, wherein the performing deformation effect processing on the target image based on the target deformation information to obtain a target effect image, comprises:
transforming a texture mapping coordinate according to the target deformation information;
sampling a pixel value from the target image based on a transformed texture mapping coordinate; and
rendering the pixel value being sampled to obtain the target effect image.

11. An apparatus for generating an effect, comprising:
an effect component creating module, configured to create an effect component based on a first operation triggered by a user, wherein the effect component comprises a deformable face image of a reference object, and reference face key points are set on a face of the reference object;
a face key point movement module, configured to detect a moving operation of the user on the reference face key points and obtain target position information of the reference face key points after being moved;
an effect parameter detection module, configured to detect an effect parameter set by the user; and
an effect generation module, configured to generate a deformation effect according to the target position information and the effect parameter, wherein the deformation effect is used for performing deformation effect processing on a face of an object in a target image, and a category of the object in the target image is identical to a category of the reference object.

12. An apparatus for generating an effect image, comprising:
a deformation effect acquisition module, configured to obtain a target image and a deformation effect;
an initial face key point information determination module, configured to determine initial face key point information of an object in the target image;
a transformed face key point information acquisition module, configured to transform the initial face key point information based on the deformation effect to obtain transformed face key point information;
a target deformation information determination module, configured to determine target deformation information according to the transformed face key point information and the initial face key point information; and
a target effect image acquisition module, configured to perform deformation effect processing on the target image based on the target deformation information to obtain a target effect image.

13. An electronic device, comprising:
one or more processors; and
a storage apparatus, configured to store one or more programs,
wherein the one or more programs, when executed by the one or more processors, cause the one or more processors to implement the method for generating the effect according to any one of claims 1 to 7 or the method for generating the effect image according to any one of claims 8 to 10.

14. A storage medium comprising computer-executable instructions, wherein the computer-executable instructions, when executed by a computer processor, are used for executing the method for generating the effect according to any one of claims 1 to 7 or the method for generating the effect image according to any one of claims 8 to 10.
